(19) United States
(12) Patent Application Publication
(10) Pub. No.: US 2026/0086379 A1
(43) Pub. Date: Mar. 26, 2026

(54) DYNAMIC BEAM ADJUSTMENT DEVICE, LASER PROCESSING SYSTEM AND LASER PROCESSING METHOD

(71) Applicant: Industrial Technology Research Institute, Hsinchu (TW)

(72) Inventors: ZIH-YI LI, Tainan City (TW); YING-TSO LIN, Hualien County (TW); CHIA-YU HU, Tainan City (TW); CHING-CHAN CHEN, Tainan City (TW); SHANG-YU HSU, Tainan City (TW)

(21) Appl. No.: 18/943,378

(22) Filed: Nov. 11, 2024

(30) Foreign Application Priority Data
Sep. 23, 2024 (TW) 113135942

(51) Int. Cl. G02B 27/09; B23K 26/067; G02B 27/10; G02B 27/28

(52) U.S. Cl. CPC G02B 27/0944; B23K 26/067; G02B 27/106; G02B 27/283

(57) ABSTRACT

The laser processing system of the disclosure has a beam emitting module, a dynamic beam adjustment device, a focusing lens assembly, and a processing platform. The beam emitting module provides a laser beam. The dynamic beam adjustment device has a beam wavefront modulation module and a beam shaping unit. The focusing lens assembly receives the transformed beam after Fourier transform and focuses the transformed beam into a processing beam. The processing platform holds the workpiece and moves along a movement direction. The processing beam processes the interior of the workpiece along a modification direction when the processing platform moves along the movement direction.

### CROSS REFERENCE TO RELATED APPLICATION

This application claims the benefits of Taiwan application Serial No. 113135942, filed on Sep. 23, 2024, the disclosures of which are incorporated by references herein in its entirety.

### TECHNICAL FIELD

The disclosure is in related to a beam adjustment device, a processing system and a processing method, more particularly to a dynamic beam adjustment device, a laser processing system and a laser processing method.

### BACKGROUND

Generally speaking, focusing light beams onto the interior of a workpiece, such as glass, by means of a traditional lens is to use the refractive properties of the lens to focus parallel light beams into a single point. However, when the parallel light beams pass through the lens, due to the curvature of the lens surface, beams far away from the optical axis and other light beams closer to the optical axis will converge at different points respectively. This results in a longitudinal spherical aberration, so as to generate an elongated elliptical focal point distribution.

In laser processing, the phenomenon of longitudinal spherical aberration causes the focal point to disperse, so as to let the light beams not fully converge at a single point. This results in a focal line rather than an ideal focal point. Because of this dispersion, the energy density per unit area is lowered down, and it may affect both processing efficiency and precision. Different positions of focal points are able to lead to inconsistencies in processing depths. In prior arts, dynamically adjusting the spot size of the focal point is hard to achieved. That is, the purpose to eliminate aberrations for correcting spherical aberration may not be possible.

Besides, the prior correction of spherical aberration typically adopts a single beam incident method. Especially, a single slit can only correspond to one beam, so if spherical aberration is to be corrected, beam splitting just cannot execute. Since the phase of a single slit cannot be superimposed in another direction, dual-beam splitting processing and spherical aberration correction cannot be carried out simultaneously as well. As a result, this method cannot be applied in laser processing that involves splitting into two (or more) optical waveguide paths, and it may reduce processing efficiency.

### SUMMARY

The disclosure provides a dynamic beam adjustment device, a laser processing system and a laser processing method, which are able to resolve the issue of longitudinal spherical aberration for improving both processing efficiency and precision.

The disclosure provides an embodiment, which is a laser processing system for processing a workpiece. The laser processing system has a beam emitting module, a dynamic beam adjustment device, a focusing lens assembly, and a processing platform. The beam emitting module provides a laser beam. The dynamic beam adjustment device has a beam wavefront modulation module and a beam shaping unit. The beam wavefront modulation module receives the laser beam and adjusts wavefronts of the laser beam, so as to obtain an adjusted laser beam. The beam shaping unit has a beam splitting module, an optical modulation module, a beam combining module, and a Fourier transform module. The beam splitting module receives the adjusted laser beam, and splits the adjusted laser beam into a first beam and a second beam. The optical modulation module respectively receives the first beam and the second beam, and performs phase adjustments on the first beam and the second beam to form a first shaped beam and a second shaped beam. The beam combining module respectively receives the first shaped beam and the second shaped beam after the phase adjustments, and synthesizes the first shaped beam and the second shaped beam into a combined beam. The Fourier transform module performs a Fourier transform on the combined beam to generate a transformed beam. A focusing lens assembly receives the transformed beam after the Fourier transform and focuses the transformed beam into a processing beam. The processing platform holds the workpiece and moves along a movement direction. The processing beam processes the interior of the workpiece along a modification direction when the processing platform moves along the movement direction, the movement direction is opposite to the modification direction.

The disclosure provides an embodiment, which is a dynamic beam adjustment device. The dynamic beam adjustment device has a beam wavefront modulation module and a beam shaping unit. The beam wavefront modulation module receives a laser beam and adjusts wavefronts of the laser beam, so as to obtain an adjusted laser beam. The beam shaping unit has beam splitting module, an optical modulation module and a beam combining module. The beam splitting module receives the adjusted laser beam, and splits the adjusted laser beam into a first beam and a second beam. The optical modulation module respectively receives the first beam and the second beam, and performs phase adjustments on the first beam and the second beam to form a first shaped beam and a second shaped beam. The beam combining module respectively receives the first shaped beam and the second shaped beam after the phase adjustments, and synthesizes the first shaped beam and the second shaped beam into a combined beam.

The disclosure discloses an embodiment that is a laser processing method. The laser processing method has the following steps of: adjusting wavefronts of a laser beam through a beam wavefront modulation module and obtaining an adjusted laser beam; splitting the adjusted laser beam into at least two beams through the beam splitting module; performing phase adjustments on at least two beams through an optical modulation module; and after the phase adjustments, receiving at least two beams, which are synthesized into a combined beam.

As a conclusion, the disclosed dynamic beam adjustment device, the laser processing system and the laser processing method are able to meet the requirements of simultaneous beam splitting, aberration correction and position offset in a laser processing procedure, which has a multi-branch optical waveguide path.

Furthermore, the disclosure allows that of adjusting the shape of laser beam. By adjusting the wavefront of the laser beam and coordinating with the beam shaping unit, it can modify the splitting ratio corresponding to two different beams, thereby processing the desired waveguide structures, such as tapered waveguides, symmetric or asymmetric waveguides.

In addition, this disclosure effectively resolves the issue of longitudinal spherical aberration. After phase adjustment, the energy density per unit area is higher, which can improve both processing efficiency and precision.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 illustrates a schematic view of a laser processing system of the disclosure;

FIG. 2 illustrates a schematic view of a dynamic beam adjustment device of the disclosure;

FIG. 3 illustrates a top view of an embodiment of the workpiece being processed of the disclosure;

FIG. 4 illustrates a schematic view of dual beams and corresponding phase periods according to the disclosure;

FIG. 5A illustrates a cross-sectional view of the workpiece to be processed from a side view, as shown in FIG. 3;

FIG. 5B illustrates a schematic view of the processing waveguide of the disclosure;

FIG. 6A illustrates a cross-sectional view of the workpiece to be processed from a side view in prior arts;

FIG. 6B illustrates a schematic view of the processing waveguide in prior arts;

FIG. 7 illustrates a schematic view of the beams with the aberration corrections of the disclosure and prior arts; and

FIG. 8 illustrates a flow chart of the laser processing method of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The terms “including”, “comprising”, “having” and the like mentioned in this disclosure are all open terms; i.e., implying only “including but not limited to”.

In the description of embodiments, when terms such as “first”, “second”, “third”, “fourth” etc. are used to describe elements, they are only used to distinguish these elements from each other, but not limit order or importance of any of these elements.

In the descriptions of various embodiments, the so-called “coupling” or “connection” may refer to two or a plurality of components making physical or electrical contact directly or indirectly with each other, or refer to the mutual operation or action of two or a plurality of elements.

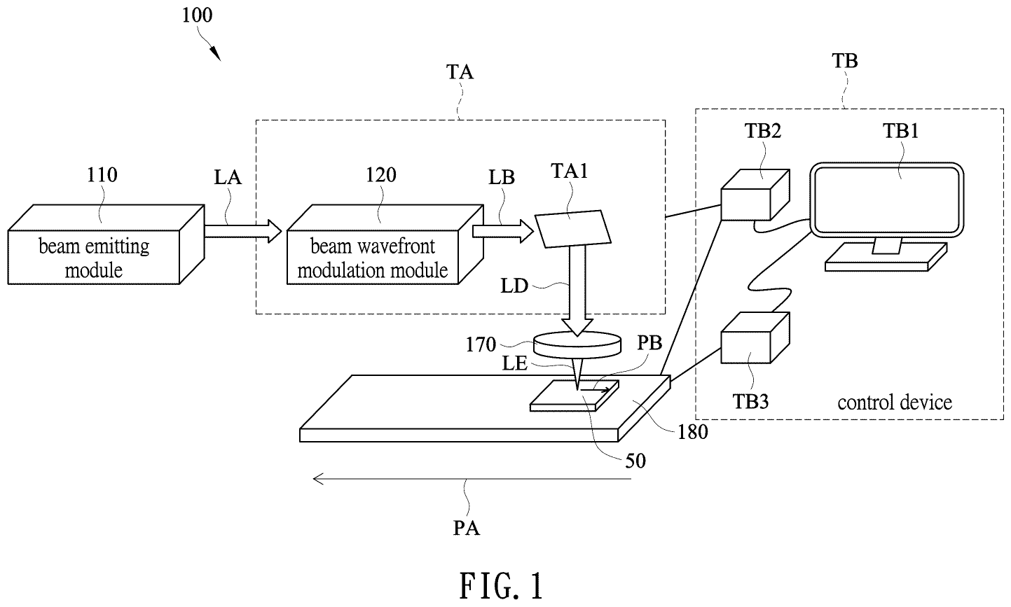

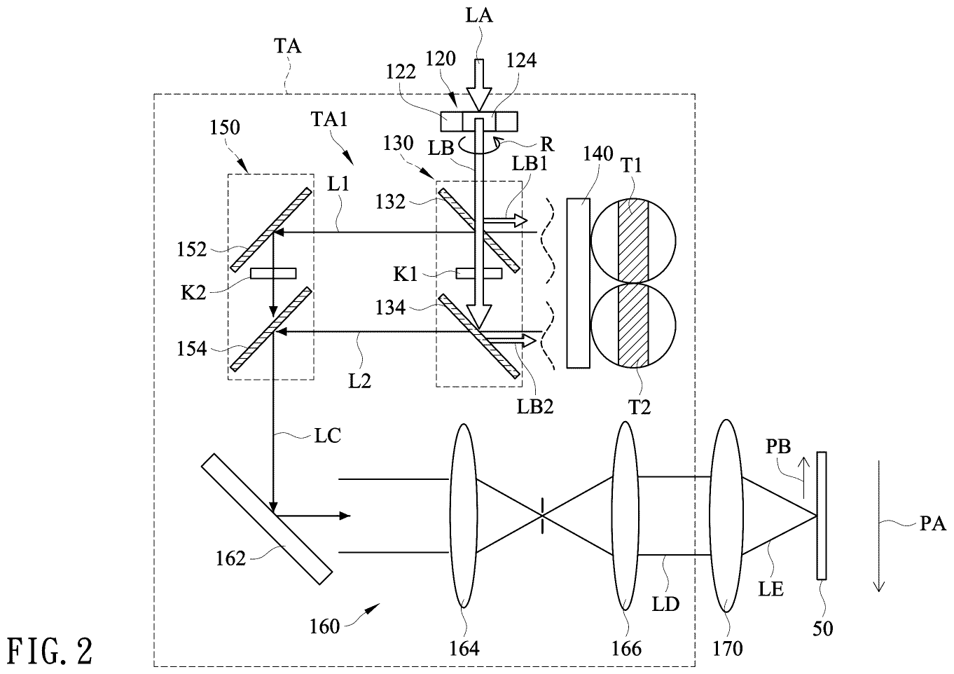

FIG. 1 illustrates a schematic view of a laser processing system of the disclosure. FIG. 2 illustrates a schematic view of a dynamic beam adjustment device of the disclosure. According to FIG. 1 and FIG. 2, a laser processing system 100 provided by the disclosure has a beam emitting module 110, a dynamic beam adjustment device TA, a control device TB, a focusing lens assembly 170, and a processing platform 180. The processing platform 180 holds a workpiece 50, and moves along a movement direction PA. The workpiece 50 is an object to be modified by a laser beam, and is produced by transparent materials or non-transparent materials, wherein the transparent materials are such as borosilicate glass and alkali aluminosilicate glass. It is to be noted that the processing platform 180 can be moved by a moving element that is disposed internally or externally, or by the control device TB.

The dynamic beam adjustment device TA has a beam wavefront modulation module 120 and a beam shaping unit TA1. The beam shaping unit TA1 has a beam splitting module 130, an optical modulation module 140, a beam combining module 150, and a Fourier transform module 160. As to another embodiment, the beam shaping unit TA1 is flexibly with the beam splitting module 130, the optical modulation module 140 and the beam combining module 150. That is, whether other modules are added or not depends on real situations.

The beam emitting module 110 disclosed by the disclosure provides a laser beam LA. The form of the beam emitting module 110 can be adjusted according to the required processing type or the different optical components being used. For instance, the beam emitting module 110 can be an ultrafast laser or a non-ultrafast laser, where the ultrafast laser includes a picosecond laser, a femtosecond laser, or an attosecond laser; the non-ultrafast laser includes a continuous wave laser and long-pulse lasers, including nanosecond, microsecond, and millisecond levels.

This disclosure adjusts the wavelength, the pulse repetition rate, the pulse width, and energy of the laser beam LA according to the type of laser. In one embodiment, the range of the wavelength of the laser beam LA is between 400 nm and 2000 nm, wherein 1550 nm is a safe wavelength for human eyes. The pulse repetition rate of the laser beam LA is in the range of 300 kHz to 5 MHz, for example. The pulse width of the laser beam LA is above 100 fs as an example. The range of the pulse energy of the laser beam LA is between 100 nj and 1000 nj.

The beam wavefront modulation module 120 of the dynamic beam adjustment device TA of the disclosure is an optical device for controlling and modifying the wavefront state of the laser beam LA. The beam emitting module 110 emits the laser beam LA to the dynamic beam adjustment device TA. The beam wavefront modulation module 120 receives the laser beam LA and adjusts the wavefronts of the laser beam LA, so as to obtain an adjusted laser beam LB. In another embodiment, according to FIG. 2, the beam wavefront modulation module 120 has a rotation platform 122 and a half-wave plate 124. The rotation platform 122 is an electric rotating translation stage, and the half-wave plate 124 is mounted on the rotation platform 122, wherein the half-wave plate 124 rotates along a rotation direction R via the rotation platform 122. Hence, the wavefronts of the laser beam LA are adjusted after the laser beam LA goes through the half-wave plate 124. In other words, through a physical mechanism, the optical element, such as the half-wave plate 124, is rotated, the traveling direction, profile, etc. of the laser beam LA can be altered. For other embodiments, the beam wavefront modulation module 120 is able to adjust the direction of the laser beam LA by means of the orientation change of the liquid crystal molecules.

The beam splitting module 130 of the beam shaping unit TA1 in the disclosure is to receive the adjusted laser beam LB, and splits the adjusted laser beam LB into a first beam LB1 and a second beam LB2. The beam splitting module 130 can be equipped with a corresponding number of beam splitting elements based on the required number of split beams. For example, if two split beams are needed, two beam splitting elements should be installed, so that the adjusted laser beam LB passes through the beam splitting elements and is split into two beams. However, this is not limited to this specific case. Further, the numbers of the split beam and the split beam element may be greater than two respectively. In the present embodiment, the beam splitting module 130 has a first beam splitting element 132 and a second beam splitting element 134. The aforementioned beam wavefront modulation module 120 can adjust the shape of the laser beam LA as required, so that the direction of the adjusted laser beam LB is changed, for example, 30 degrees or 45 degrees. By means of the first beam splitting element 132 and the second beam splitting element 134, a first beam LB1 is produced after the adjusted laser beam LB goes through the first beam splitting element 132, continuously a second beam LB2 is produced after the adjusted laser beam LB goes through the second beam splitting element 134. As it can be seen, through the beam wavefront modulation module 120 adjusting the shape of the laser beam LA, the adjustment of the adjusted laser beam LB and the beam shaping unit TA1, different beam splitting ratios of the first beam LB1 and the second beam LB2 will be obtained.

As for the present embodiment, a half-wave plate K1 is disposed between the first beam splitting element 132 and the second beam splitting element 134. The half-wave plate K1 is configured to change the direction of the light beam, in order to guide the adjusted laser beam LB to the second beam splitting element 134. It is to be noted that the first beam splitting element 132 and the second beam splitting element 134 can be a beam splitter or a polarizer. A beam splitter is an optical element that separates a light beam based on the ratio of reflection and transmission, while a polarizer is an optical element that separates or combines light beams based on their polarization states. It can be a polarization beam splitter (PBS). Both the ranges of the sizes of the first beam splitting element 132 and the second beam splitting element 134 are within 8 mm to 20 mm. In addition, by adjusting the rotation and offset angle of the first beam splitting element 132 and the second beam splitting element 134, the aberration of the first beam LB1 and the second beam LB2 can be modified.

An optical modulation module 140 of the beam shaping unit TA1 respectively receives the first beam LB1 from the first beam splitting element 132 and the second beam LB2 from the second beam splitting element 134, and performs phase adjustments on the first beam LB1 and the second beam LB2 to form a first shaped beam L1 and a second shaped beam L2.

In one embodiment, the optical modulation module 140 can be a semi-solid-state or solid-state beam steering device. As an example, the semi-solid-state or solid-state beam steering device can be a spatial light modulator (SLM) of Liquid Crystal on Silicon (LCoS), which is an optical element capable of modulating the amplitudes and phases of the first beam LB1 and the second beam LB2. The optical modulation module 140 functions to regulate the phase of a prismatic lens or a grating pattern, wherein the grating period of the prismatic lens ranges between 8 μm and 300 μm. Alternatively, the optical modulation module 140 provides two or more different wavefront phases and controls the beam diameter and angle for the two or more phases. Additionally, the optical modulation module 140 can also be an optical modulator of Liquid Crystal on Silicon (LCoS).

With regard to FIG. 2, the optical modulation module 140 is configured to generate diffraction patterns T1 and T2 for steering the first beam LB1 and the second beam LB2. It controls the transformation of phase patterns and the size period of the diffraction patterns T1 and T2 as well. Via the diffraction patterns T1 and T2, the phases of the first beam LB1 and the second beam LB2 are adjusted. Such as, by adjusting the periods, corresponding to the densities of the slits in the diffraction pattern T1 and the slits in the diffraction pattern T2, the phases of the first beam LB1 and the second beam LB2 can be corrected.

In this way, through obtaining the first beam LB1 and the second beam LB2 and correcting the aberration of the first beam LB1 and the second beam LB2, the first shaped beam L1 and the second shaped beam L2 is obtained. Thus, according to the periods, corresponding to the densities/sizes of the slits in the diffraction pattern T1 and the slits in the diffraction pattern T2, in order to approach the function for the offsets of the positions of the first shaped beam L1 and the second shaped beam L2.

A beam combining module 150 of the beam shaping unit TA1 receives the first shaped beam L1 and the second shaped beam L2 after the phase adjustments, and synthesizes the first shaped beam L1 and the second shaped beam L2 into a combined beam LC. Depending on the required number of the light beam to be received, the number of beam combining elements shall be installed correspondingly. For example, the required number of the light beam to be received is two, two beam combining elements should be ready, but it is not limited thereto. Further, the number of the beam combining element can be greater than two as well. The beam combining module 150 has a first beam combining element 152 and a second beam combining element 154. Through such structures, the first shaped beam L1 goes through the first beam combining element 152 and the second beam combining element 154 respectively, and the second shaped beam L2 goes through the second beam combining element 154, then a combined beam LC is generated after passing through the beam combining elements. Since the first shaped beam L1 and the second shaped beam L2 are first split and then have their aberrations corrected, the combined beam LC after beam combining possesses the respective phase periods corresponding to the first shaped beam L1 and the second shaped beam L2. In other words, through the beam splitting module 130, the optical modulation module 140, and the beam combining module 150, the beam shaping unit TA1 can simultaneously perform beam splitting, aberration correction, and position offset functions.

Further descriptions will be depicted as following. The disclosed first beam combining element 152 and the second beam combining element 154 can be a beam splitter or a polarizer. The sizes of the first beam combining element 152 and the second beam combining element 154 ranges between 8 mm and 20 mm. In an embodiment, a half-wave plate K2 is disposed between the first beam combining element 152 and the second beam combining element 154, and is used to alter the polarization state of the light beam, in order to guide the first shaped beam L1 through the first beam combining element 152 to the second beam combining element 154.

The beam shaping unit TA1 further has a Fourier transform module 160, and the Fourier transform module 160 may have a reflector assembly 162, a first lens assembly 164 and a second lens assembly 166, wherein the first lens assembly 164 and the second lens assembly 166 have focal lengths respectively. The reflector assembly 162 reflects the combined beam LC to the first lens assembly 164 and the second lens assembly 166 of the Fourier transform module 160. In the meantime, the Fourier transform module 160 performs a Fourier transform on the combined beam LC to generate a transformed beam LD.

The focusing lens assembly 170 receives the transformed beam LD after the Fourier transform and focuses the transformed beam LD into a processing beam LE. Besides, the focusing lens assembly 170 is with a focal length thereof, and the focal lengths of the first lens assembly 164, the second lens assembly 166 and the focusing lens assembly 170 are adjustable based on a real situation, such as the distance of the workpiece 50.

Under the condition without changing the processing beam LE, the processing beam LE processes the interior of the workpiece 50 along a modification direction PB when the processing platform 180 moves along a movement direction PA, the modification direction PB is opposite to the movement direction PA, wherein the processing beam LE has the modification direction PB relative to the workpiece 50.

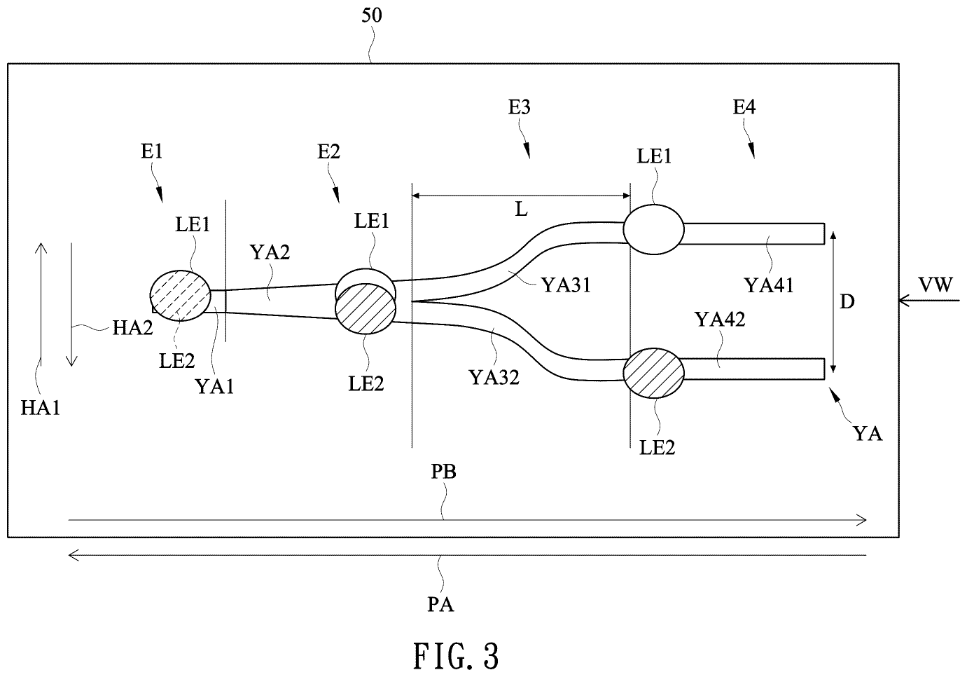

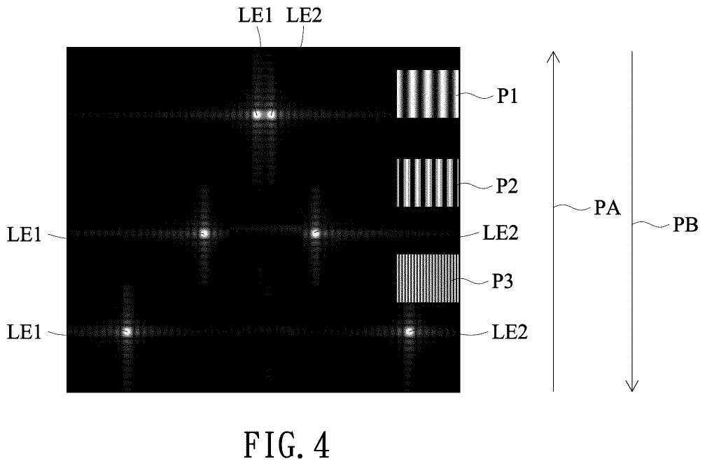

FIG. 3 illustrates a top view of an embodiment of the workpiece being processed of the disclosure. FIG. 4 illustrates a schematic view of dual beams and corresponding phase periods according to the disclosure. Please refer to FIG. 1, FIG. 3 and FIG. 4, FIG. 3 is a top view of the workpiece 50 compared to the view angle of the workpiece 50 of FIG. 1. After being split and shaped by the beam shaping unit TA1, the processing beam LE forms a first processing beam LE1 and a second processing beam LE2, each with its own phase period. As shown in FIG. 3, along the modification direction PB, there are plural regions as a first region E1, a second region E2, a third region E3, and a fourth region E4, where the number of regions is adjusted based on desired waveguide shapes to be formed when in real processing conditions.

The beam splitting module 130 and the optical modulation module 140 of the beam shaping unit TA1 are capable of adjusting the positions of the first processing beam LE1 and the second processing beam LE2, so as to achieve the purpose of gradual size variation. As to FIG. 3, to modify the workpiece 50 into a Y-shaped waveguide structure YA is a goal. The first region E1 is a beam entry region, forming a straight waveguide YA1. Presently, the first processing beam LE1 and the second processing beam LE2 are still overlapped. Successively, the second region E2 is a gradual size variation region, which forms a gradual size variation waveguide structure YA2. Since the first processing beam LE1 and the second processing beam LE2 each have their own phase periods, as movement occurs along the modification direction PB, the positions of the first processing beam LE1 and the second processing beam LE2 can be adjusted or shifted. As an example, the first processing beam LE1 and the second processing beam LE2 in the second region E2 move along an expanding direction HA1 and an expanding direction HA2 respectively, so as to let the first processing beam LE1 and the second processing beam LE2 be not overlapped.

The third region E3 is a curved waveguide region, the positions of the first processing beam LE1 and the second processing beam LE2 are further separated. The first processing beam LE1 has a first curved waveguide YA31 along the modification direction PB, and the second processing beam LE2 has a second curved waveguide YA32 along the modification direction PB. The paths of the first curved waveguide YA31 and the second curved waveguide YA32 are formed based on the variation of the phase periods between the first processing beam LE1 and the second processing beam LE2. The third region E3 has a curved waveguide variation length L, which is adjusted according to the phase period variation between the first processing beam LE1 and the second processing beam LE2. At last, the fourth region E4 is a processing beam output region. The first processing beam LE1 and the second processing beam LE2 respectively have a first straight waveguide YA41 and a second straight waveguide YA42. Additionally, a waveguide spacing D is between the first processing beam LE1 and the second processing beam LE2, and is gradually changed from 0 μm to 250 μm from the first region E1 to the fourth region E4. To produce symmetric or asymmetric waveguide structures, the following procedures shall be go through, such as the wavefront modulation module 120 adjusting the pattern of the laser beam LA, adjusting the wavefront of the adjusted laser beam LB as well, and the shaping performed by the beam shaping unit TA1, which corresponds to different beam splitting ratios between the first processing beam LE1 and the second processing beam LE2, thereby processing to produce the desired waveguide structure. As to other embodiments, if the beam splitting number is greater than two as required, the beam splitting ratio of three or more split processing beams and the size of their waveguide spacings can be adjusted by the beam splitting module 130 and the optical modulation module 140 of the beam shaping unit TA1.

As shown in FIG. 4, due to the different phase periods P1, P2, and P3, which are varied in different densities, hence the relative positions of the first processing beam LE1 and the second processing beam LE2 differ. Along the modification direction PB, the time of the phase period P3 is smaller than the time of the phase period P1, therefore the waveguide spacing D between the first processing beam LE1 and the second processing beam LE2 will be greater, wherein the phase period P1 corresponds to the first processing beam LE1 and the second processing beam LE2 in the second region E2, as shown in FIG. 3, the phase period P2 corresponds to the first processing beam LE1 and the second processing beam LE2 in the third region E3, as shown in FIG. 3. Similarly, the phase period P3 corresponds to the first processing beam LE1 and the second processing beam LE2 in the fourth region E4, as depicted in FIG. 3.

The waveguide spacing D gradually changes from 0 μm to 250 μm, controlled by the grating pattern of the optical modulation module 140 in FIG. 2. This is achieved by the grating period Np₁ of the first diffraction pattern T1 and the grating period Np₂ of the second diffraction pattern T2.

There is an embodiment for the equation of the waveguide spacing D as following:

$$D = f \times Δ θ ; \qquad ( 1 )$$

$$Δ θ = {sin}^{- 1} ( \frac{λ}{Np 1} ) {}_{-}^{} {{sin}_{}^{- 1}}^{} ( \frac{λ}{Np 1} ) \qquad ( 2 )$$

Wherein f is the focal length of a processing lens, such as the focusing lens assembly 170, and the range of f is between 5 mm and 20 mm. For the present embodiment, the wavelength λ of the laser beam LA is 532 nm, and f is 10 mm. When Np₁=756 μm and Np₂=768 μm, the waveguide spacing D is 0 μm. However, when Np₁=372 μm and Np₂=120 μm, the waveguide spacing D becomes 250 μm.

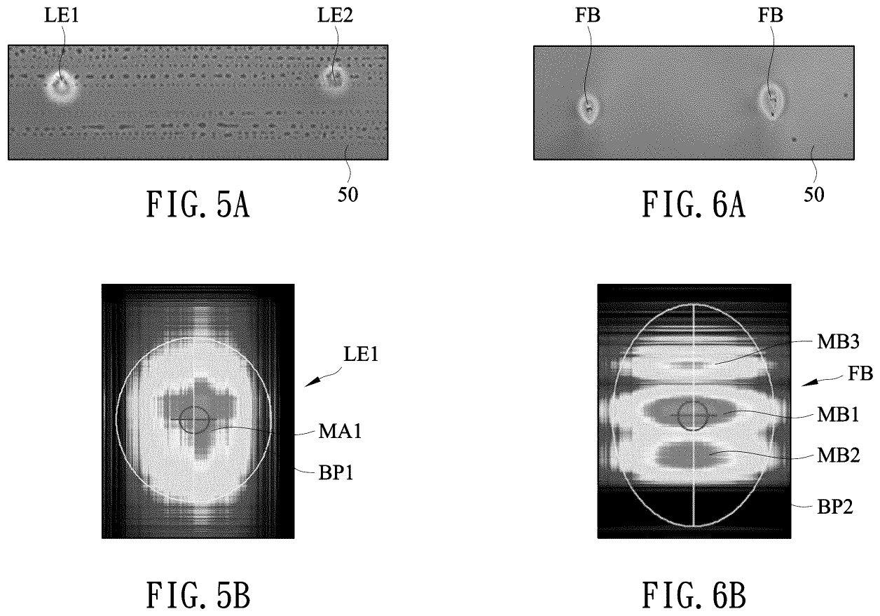

FIG. 5A illustrates a cross-sectional view of the workpiece to be processed from a side view, as shown in FIG. 3. FIG. 5B illustrates a schematic view of the processing waveguide of the disclosure. FIG. 6A illustrates a cross-sectional view of the workpiece to be processed from a side view in prior arts. FIG. 6B illustrates a schematic view of the processing waveguide in prior arts. FIG. 5A is a cross-sectional view of the workpiece 50 to be processed in FIG. 3 from a lateral side VW. It can be seen that, after the aberration correction of the first processing beam LE1 and the second processing beam LE2, a circular optical waveguide BP1 is formed, which is a single-mode waveguide with a single focal point MA1. This demonstrates that, after the phase adjustment by the optical modulation module 140, the focal point is concentrated without any longitudinal spherical aberration. On the contrary, as shown in FIG. 6A and FIG. 6B, that is a processing beam FB focused by traditional lenses. It forms a water drop optical waveguide BP2, which is a multi-film waveguide with multiple focal points MB1, MB2, and MB3. In other words, the focal points are dispersed, and with longitudinal spherical aberration. Furthermore, as seen from FIG. 5B and FIG. 6B, after the phase adjustment of the disclosure, the focal point MA1 of the first processing beam LE1 is concentrated on a single point. This results in a higher energy density per unit area, which can enhance both processing efficiency and precision.

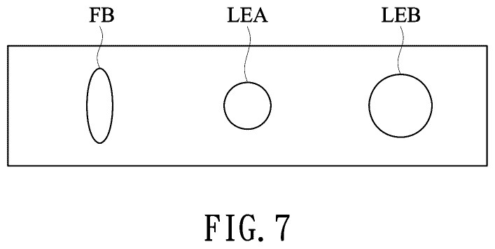

FIG. 7 illustrates a schematic view of the beams with the aberration corrections of the disclosure and prior arts. Please refer to FIG. 7. The contour shape of the processing beam FB, focused by traditional lenses in prior arts, is a water drop shape (elliptical). On the other hand, the contour shape of a processing beam LEA, after the phase adjustment by the optical modulation module 140, is circular. In addition, the dynamic beam adjustment device TA of the disclosure can also adjust the spot size of a processing beam LEB, so as to make the diameter of the processing beam LEB be larger than that of the processing beam LEA.

With reference to FIG. 1 again, additionally, the laser processing system 100 of the disclosure can also cooperate with the control device TB for enhancing the technologies of dynamic feedback and adjustment. The control device TB has a control program TB1, a drive controller TB2 and a sensing element TB3. The control program TB1 is connected with the drive controller TB2 and the sensing element TB3 respectively. The control program TB1 can input laser processing parameters, control the drive controller TB2 and collect the data from the sensing element TB3. The drive controller TB2 is a stepping motor with processor having circuit design, and connects with the dynamic beam adjustment device TA for controlling and adjusting the input parameters of the elements related to the dynamic beam adjustment device TA. The drive controller TB2 plays the role to drive the processing platform 180. In addition, the sensor TB3 is an optical sensor for detecting the distance between the dual beams on the workpiece 50 on the processing platform 180, as shown the waveguide spacing D in FIG. 3, and then dynamically adjust the related parameters of the dynamic beam adjustment device TA based on this distance.

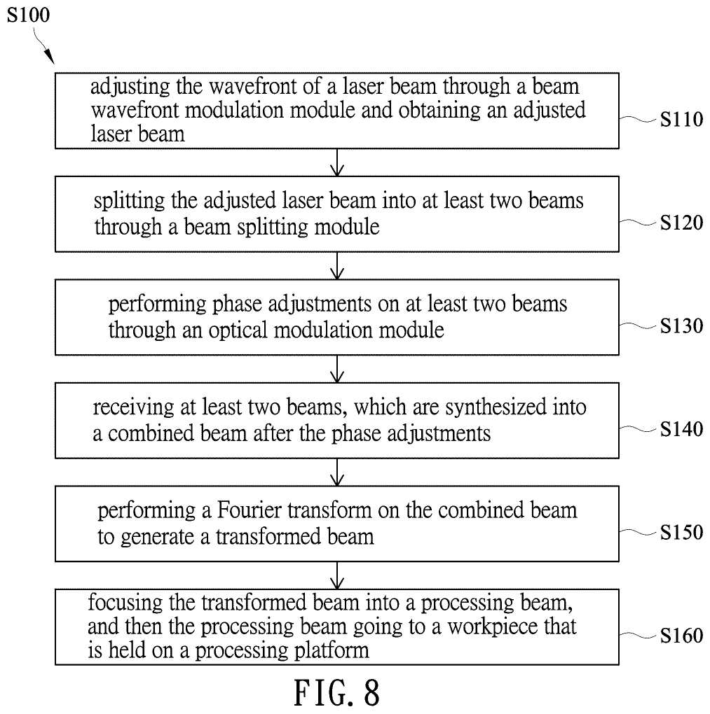

FIG. 8 illustrates a flow chart of the laser processing method of the disclosure. According to FIG. 1 and FIG. 2, which discloses the laser processing system 100. Accordingly, the laser processing method S100 has the steps of (S110) to (S160).

First, the step (S110) is proceeded, that is of adjusting the wavefront of a laser beam through a beam wavefront modulation module and obtaining an adjusted laser beam. With regard to FIG. 1 and FIG. 2, adjusting the wavefronts of a laser beam LA through a beam wavefront modulation module 120 will result in an adjusted laser beam LB.

Second, the step (S120) is proceeded, that is of splitting the adjusted laser beam LB into at least two beams through the beam splitting module 130. As shown in FIG. 1 and FIG. 2, a beam splitting module 130 splits the adjusted laser beam LB into a first beam LB1 and a second beam LB2. The step (S120) further has the following step of: adjusting the position of the beam splitting module 130 to correct the aberration of at least two beams, wherein adjusting the position of the beam splitting module 130 involves deflection operations that are rotating and offsetting the angle of the beam splitting module 130. For example, adjusting the rotation and offset angles of the first beam splitting element 132 and the second beam splitting element 134 in the beam splitting module 130 is to perform the aberration correction on the first beam LB1 and the second beam LB2.

Continuously, the step (S130) is of performing phase adjustments on at least two beams through an optical modulation module 140. As shown in FIG. 1 and FIG. 2, The optical modulation module 140 is used to generate diffraction patterns T1 and T2 that divert the first beam LB1 and the second beam LB2 and control the size period of the diffraction patterns T1 and T2. The diffraction patterns T1 and T2 are used to perform phase adjustment and gradual size variation on the first beam LB1 and the second beam LB2 respectively.

In sequence, the step (S140) is that of receiving at least two beams, which are synthesized into a combined beam LC after the phase adjustments. On the basis of FIG. 1 and FIG. 2, a beam combining module 150 receives a first shaped beam L1 and a second shaped beam L2 after the phase adjustments, and synthesizes the first shaped beam L1 and the second shaped beam L2 into a combined beam LC.

Orderly, the step (S150) is of performing a Fourier transform on the combined beam LC to generate a transformed beam LD. According to FIG. 1 and FIG. 2, a Fourier transform module 160 performs the Fourier transform on the combined beam LC to generate the transformed beam LD. In the embodiment, based on the required, the reflector assembly 162, the first lens assembly 164 and the second lens assembly 166 can be disposed in sequence. The combined beam LC is reflected to the first lens assembly 164 and the second lens assembly 166 by means of the reflector assembly 162, and thus becomes the transformed beam LD that is through the Fourier transform.

The step (S160) is of focusing the transformed beam LD into a processing beam LE, and then the processing beam LE going to a workpiece 50 that is held on a processing platform 180. As shown in FIG. 1 and FIG. 2, a focusing lens assembly 170 focuses the transformed beam LD into the processing beam LE, the processing beam LE then goes to the workpiece 50 that is held on the processing platform 180, so as to process the workpiece 50. Simultaneously, the processing platform 180 moves along a movement direction PA, so that the processing beam LE processes an interior of the workpiece 50 along a modification direction PB, wherein the movement direction PA is opposite to the modification direction PB.

As a conclusion, the disclosed dynamic beam adjustment device, the laser processing system and the laser processing method are able to meet the requirements of simultaneous beam splitting, aberration correction and position offset in a laser processing procedure, which has a multi-branch optical waveguide path.

Furthermore, the disclosure allows that of adjusting the shape of laser beam. By adjusting the wavefront of the laser beam and coordinating with the beam shaping unit, it can modify the splitting ratio corresponding to two different beams, thereby processing the desired waveguide structures, such as tapered waveguides, symmetric or asymmetric waveguides.

In addition, this disclosure effectively resolves the issue of longitudinal spherical aberration. After phase adjustment, the energy density per unit area is higher, which can improve both processing efficiency and precision.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A laser processing system, for processing a workpiece, comprising:
a beam emitting module, providing a laser beam;
a dynamic beam adjustment device, comprising:
a beam wavefront modulation module, receiving the laser beam and adjusting wavefronts of the laser beam, so as to obtain an adjusted laser beam; and
a beam shaping unit, comprising:
a beam splitting module, receiving the adjusted laser beam, and
splitting the adjusted laser beam into a first beam and a second beam;
an optical modulation module, respectively receiving the first beam and the second beam, and performing phase adjustments on the first beam and the second beam to form a first shaped beam and a second shaped beam;
a beam combining module, respectively receiving the first shaped beam and the second shaped beam after the phase adjustments, and synthesize the first shaped beam and the second shaped beam into a combined beam; and
a Fourier transform module, performing a Fourier transform on the combined beam to generate a transformed beam;
a focusing lens assembly, receiving the transformed beam after the Fourier transform and focusing the transformed beam into a processing beam; and
a processing platform, holding the workpiece and moving along a movement direction;
the processing beam processing an interior of the workpiece along a modification direction when the processing platform moves along the movement direction, the movement direction being opposite to the modification direction.

2. The laser processing system according to claim 1, wherein the optical modulation module provides two or more types of wavefront phases, and has at least two diffraction patterns, in order to respectively perform the phase adjustments on the first beam and the second beam.

3. The laser processing system according to claim 1, wherein a range of a grating period of the optical modulation module is between 8 μm and 1000 μm.

4. The laser processing system according to claim 1, wherein the beam splitting module has at least two beam splitting elements and at least one half-wave plate, the half-wave plate being positioned between the two beam splitting elements.

5. The laser processing system according to claim 1, wherein the Fourier transform module has a reflector assembly that reflects the combined beam.

6. The laser processing system according to claim 1, wherein the beam combining module has at least two beam combining elements and a half-wave plate.

7. The laser processing system according to claim 1, wherein the beam wavefront modulation module has a rotation platform and a half-wave plate, the half-wave plate being mounted on the rotation platform.

8. The laser processing system according to claim 1 further comprising a control device that regulates the dynamic beam adjustment device and the processing platform.

9. The laser processing system according to claim 8, wherein the control device has a control program, a drive controller and a sensing element, the control program being connected with the drive controller and the sensing element respectively.

10. A dynamic beam adjustment device, comprising:
a beam wavefront modulation module, receiving a laser beam and adjusting wavefronts of the laser beam, so as to obtain an adjusted laser beam; and
a beam shaping unit, comprising:
a beam splitting module, receiving the adjusted laser beam, and splitting the adjusted laser beam into a first beam and a second beam;
an optical modulation module, respectively receiving the first beam and the second beam, and performing phase adjustments on the first beam and the second beam to form a first shaped beam and a second shaped beam; and
a beam combining module, receiving the first shaped beam and the second shaped beam after the phase adjustments, and synthesizing the first shaped beam and the second shaped beam into a combined beam.

11. The dynamic beam adjustment device according to claim 10 further comprising: a Fourier transform module, performing a Fourier transform on the combined beam to generate a transformed beam, wherein the Fourier transform module has a reflector assembly that reflects the combined beam.

12. The dynamic beam adjustment device according to claim 10, wherein the optical modulation module provides two or more types of wavefront phases, and has at least two diffraction patterns, in order to respectively perform the phase adjustments on the first beam and the second beam.

13. The dynamic beam adjustment device according to claim 10, wherein a range of a grating period of the optical modulation module is between 8 μm and 1000 μm.

14. The dynamic beam adjustment device according to claim 10, wherein the beam splitting module has at least two beam splitting elements and at least one half-wave plate, the half-wave plate being positioned between the two beam splitting elements.

15. The dynamic beam adjustment device according to claim 10, wherein the beam wavefront modulation module has a rotation platform and a half-wave plate, the half-wave plate being mounted on the rotation platform.

16. A laser processing method, comprising the steps of:
adjusting wavefronts of a laser beam through a beam wavefront modulation module and obtaining an adjusted laser beam;
splitting the adjusted laser beam into at least two beams through the beam splitting module;
performing phase adjustments on at least two beams through an optical modulation module; and
after the phase adjustments, receiving at least two beams, which are synthesized into a combined beam.

17. The laser processing method according to claim 16, wherein the step of splitting the adjusted laser beam into at least two beams through the beam splitting module further comprises the step of:
adjusting a position of the beam splitting module to perform aberration corrections for the two beams.

18. The laser processing method according to claim 16, further comprising the step of:
performing a Fourier transform on the combined beam to generate a transformed beam; and
after the Fourier transform, focusing the transformed beam into a processing beam, continuously to a workpiece on a processing plate.

19. The laser processing method according to claim 18, wherein the step of after the Fourier transform, focusing the transformed beam into a processing beam, continuously to a workpiece on a processing plate further comprises the step of:
the processing beam processing an interior of the workpiece along a modification direction when the processing platform moves along a movement direction, the movement direction being opposite to the modification direction.
